(19) United States
(12) Patent Application Publication
(10) Pub. No.: US 2016/0154931 A1
(43) Pub. Date: Jun. 2, 2016

(54) METHOD AND DEVICE FOR DETECTING CHROMOSOMAL ANEUPLOIDY

(71) Applicant: BGI GENOMICS CO., LIMITED, Shenzhen, Guangdong (CN)

(72) Inventors: Jing ZHENG, Shenzhen, Guangdong Province (CN); Chunlei ZHANG, Shenzhen, Guangdong Province (CN); Shengpei CHEN, Shenzhen (CN); Haojun JIANG, Shenzhen, Guangdong Province (CN); Weiwei XIE, Shenzhen (CN); Fang CHEN, Shenzhen (CN)

(73) Assignee: BGI GENOMICS CO., LIMITED, Shenzhen, Guangdong (CN)

(21) Appl. No.: 14/905,617

(22) PCT Filed: Jul. 17, 2013
(86) PCT No.: PCT/CN2013/079495

§ 371 Date: Jan. 15, 2016

(51) Int. Cl. G06F 19/22; G06F 19/24

(52) U.S. Cl. CPC G06F 19/22; G06F 19/24

(57) ABSTRACT

A method and a device for detecting chromosomal aneuploidy are provided. The method includes: obtaining the distribution of the sequencing result of test samples on a reference sequence, i.e., the number of sequence reads falling within each window divided on the reference sequence, wherein the test samples comprise target samples derived from target individuals and control samples derived from normal individuals; calculating the deviation statistic of each target sample in each window; comparing the average value of the deviation statistics on a certain chromosome of the target samples with a corresponding deviation threshold, and determining whether there is a deletion or duplication in the chromosome according to the comparison results, wherein the deviation threshold is set according to the deviation statistics of all normal individuals on the chromosome.

### BACKGROUND

1. Technical Field

The present invention relates to the technical fields of genomics and bioinformatics, and particularly to a method and a device for detecting chromosomal aneuploidy.

2. Related Art

A chromosome is a primary component of a nucleus. A normal person has 46 somatic chromosomes with a certain morphology and structure. A karyotype generally refers to a characteristic of the chromosomal phenotype, e.g., quantity, length and the like. Karyotype detection is capable of reflecting chromosomal abnormities. For example, aneuploidy (deletion or duplication) of a chromosome has an important role in genetic studies, e.g., the detection of the fetal chromosome karyotype facilitates the reduction of birth risk.

Prenatal detection techniques commonly used presently are divided into non-invasive prenatal detection techniques and invasive prenatal detection techniques. Non-invasive prenatal detection techniques include: 1) detection of pregnancy serum and urine components utilizing serum labels such as alpha fetoprotein (AFP), free β-human chorionic gonadotrophin (β-HCG) and pregnancy-associated plasma protein-A (PAPP-A), so as to calculate the risk of Downs syndrome; 2) visual screening of fetuses using a physical method, e.g., B ultrasound, X-ray, CT, magnetic resonance and the like; and 3) preimplantation genetic diagnosis (PGD) involving genetic analysis of gametes or embryos before they are transferred into a uterine cavity, and the like. The invasive prenatal detection techniques include villus biopsy at the early pregnancy stage, fetal cordocentesis at the intermediate pregnancy stage, amniocentesis, embryoscopy, embryo biopsy, and the like.

Presently, results from the non-invasive prenatal detection techniques are not adequately reliable, with both high false positive and false negative rates. Though the invasive prenatal detection techniques are highly accurate, risks are faced by pregnant women and fetuses, e.g., abortion or amniotic cavity inflammation.

### SUMMARY

According to one aspect of the present invention, a method for detecting chromosomal aneuploidy is provided, including the steps as follows: comparing the distribution of the sequencing results of test samples to a reference sequence, wherein the test samples comprise target samples derived from M target individuals and control samples derived from N normal individuals, M and N are positive integers, the sequencing results include a plurality of sequence reads, the reference sequence is divided into multiple windows, and the distribution of the sequencing results of the test sample on the reference sequence is reported as the number of sequence reads r(i,j) falling within each of the windows, wherein i is the serial number of the windows, j is the serial number of the test samples, and i and j are positive integers; calculating the relative sequence number R(i,j)=r(i,j)/rp(j) of each test sample in each of the windows, wherein rp(j) is an average value of r(i,j) of sample j; calculating the deviation statistic Z(i,j)=[R(i,j)−mean(i)]/sd(i) of each target sample in each window, wherein mean(i) is the average value of R(i,j) in window i, and sd(i) is the standard deviation of R(i,j) in window i; and comparing the average value Zp(c,j) of Z(i,j) on chromosome c of the target samples with a deviation threshold of chromosome c, and determining whether there is a deletion or duplication in chromosome c according to the comparison results, wherein the deviation threshold is set according to the deviation statistics of all the normal individuals on chromosome c.

According to another aspect of the present invention, a device for detecting chromosomal aneuploidy is provided, including a data input unit, configured to input data; a data output unit, configured to output data; a storage unit, configured to store data, and containing an executable program therein; a processor, in connection with the data input unit, the data output unit and the storage unit, configured to execute the executable program stored in the storage unit, wherein the execution of the program includes performing a method for detecting chromosomal aneuploidy.

According to still another aspect of the present invention, provided is a computer readable storage medium, configured to store a program executable by a computer. Those of ordinary skill in the art can understand that, when the program is executed, all or a part of the steps of the above method for detecting chromosomal aneuploidy can be performed by relevant hardware under instructions. The storage medium can include a read-only memory, a random access memory, a magnetic disk or an optical disk, and the like.

A difference between a test sample and a reference sequence is reflected by the deviation statistic according to a method of the present invention. The presence of a chromosomal deletion or duplication in the target sample is determined based on the deviation threshold set from the normal samples, providing a means for detecting chromosomal aneuploidy using the sequencing technique, which can sensitively detect an abnormality in the copy number of any chromosome.

### BRIEF DESCRIPTION OF THE DRAWINGS

The above and/or additional aspects and advantages of the present invention will become evident and easy to understand from the description of the embodiments in conjunction with the following accompanying drawings, wherein:

FIG. 1 is a schematic flowchart of a detection method according to one embodiment of the present invention;

FIG. 2 is a schematic flowchart of a window-dividing method according to another embodiment of the present invention; and

FIG. 3 is a schematic flowchart of a GC calibrating method according to another embodiment of the present invention.

### DETAILED DESCRIPTION

### Example 1

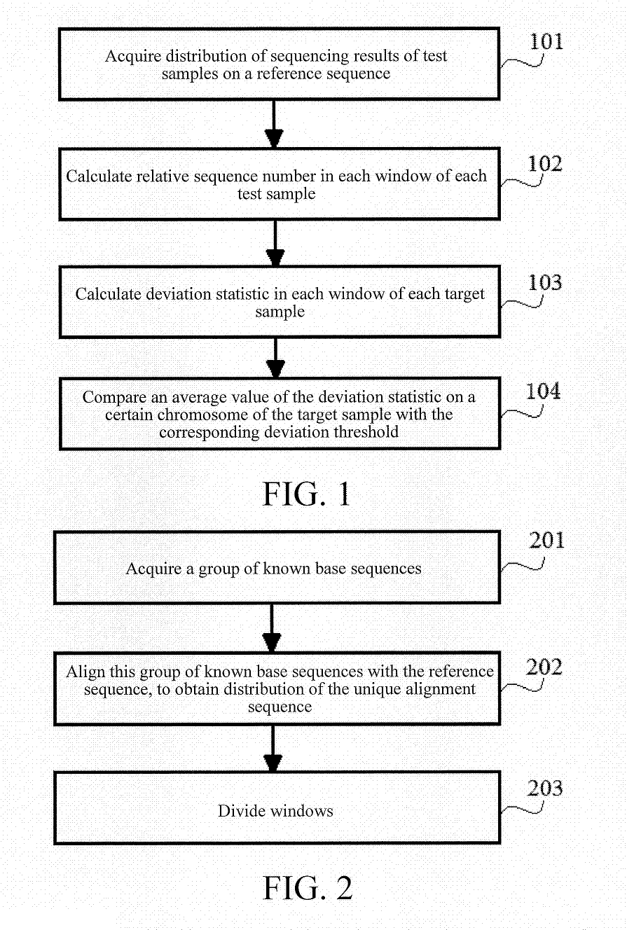

According to one embodiment of the present invention, a method for detecting chromosomal aneuploidy is provided, with reference to FIG. 1, including the steps as follows:

101. Obtaining the Distribution of Sequencing Results of a Test Sample on a Reference Sequence

(1) The test samples comprise target samples derived from M target individuals and control samples derived from N normal individuals, and M and N are positive integers.

The target individuals refer to individuals requiring the detection, e.g., pregnant women requiring prenatal detection, and the normal individuals refer to predetermined normal individuals. Generally, the target individual and the normal individual are the same species, preferably having approximately similar basic conditions. For example, if the target individual is a pregnant woman, the normal individual can be a normal pregnant woman with a normal fetus at a similar week of pregnancy.

In this embodiment, the sources of the target samples and the control samples are not limited, and for example can be selected from the group consisting of: maternal peripheral blood, maternal urine, fetal trophoblast cells of maternal cervix, maternal cervical mucus, fetal nucleated red blood cells, and the like, as long as nucleic acid samples containing genetic information of the fetuses can be extracted therefrom. In this embodiment, the target sample and the control sample preferably have the same source, e.g., preferably maternal peripheral blood, allowing non-invasive prenatal detection to be performed on the fetuses by a simple and convenient sample acquisition mode. Because the autogeneic nucleic acids of the pregnant woman will be present in the sample in addition to the fetal nucleic acids, in order to avoid interference thereof in the detection results, the pregnant woman herself should have no chromosomal aneuploidy problem, and this determination can be readily made in general. In other embodiments, the samples can be obtained using an invasive method. For example, the samples can be derived from fetal cord blood, placenta tissues or chorionic tissues, uncultured or cultured amniotic fluid cells, villus histocytes and the like.

In this embodiment, the method and equipment for extracting nucleic acids from the sample for use in sequencing are not limited, and the extraction can be performed employing various existing methods, for example, commercial kits for extracting nucleic acids.

It should be explained that, if there are more than two target individuals, i.e., M≧2, each target individual can respectively form a group of test samples with N normal individuals, namely the test samples have a total number of N+1, a total number of M groups of test samples are obtained, and each group is subjected to detection and calculation respectively according to the method provided. Alternatively, M target individuals and N normal individuals can form a group of test samples for the performance of detection and calculation, i.e., the test samples have a total number of N+M. In this embodiment, a total number of the test samples of N+1 is preferably employed.

(2) Sequencing results of the test samples include a plurality of sequence reads (i.e., reads).

Because the normal individual(s) are selected in advance, any detection or calculation data with regard to the control sample(s) can be generated and saved in advance. In this embodiment, this mode of presetting correlated data of the control sample is employed, the data are read and used as required, and unnecessary details are no longer given for the control sample. In other embodiments, synchronous detection and calculation of the control sample can be employed.

Based on the fact that embodiments of the present invention have no special dependence on the sequencing method or equipment used for the samples, nucleic acids extracted from the samples are usually fragmented, and corresponding library preparation is performed according to the sequencing method selected, followed by sequencing. For example, the third generation of sequencing platforms (Metzker M L. Sequencing technologies—the next generation. Nat Rev Genet. 2010 January; 11(1):31-46) can be used, including, but not limited to, true single molecule sequencing techniques (True Single Molecule DNA sequencing) from Helicos Corporation, single molecule real-time sequencing (single molecule real-time (SMRT™)) from Pacific Biosciences Corporation, semiconductor sequencing technique from Life Technologies Corporation, and the like. In this embodiment, the semiconductor sequencing platform from Life Technologies Corporation is preferably employed. When a plurality of target samples must be detected at the same time, each sample may be tagged with different barcodes, for use in the discrimination of samples during a sequencing process (Micah Hamady, Jeffrey J Walker, J Kirk Harris et al. Error-correcting barcoded primers for pyrosequencing hundreds of samples in multiplex. Nature Methods, 2008, March, Vol. 5 No. 3), thereby allowing sequencing of multiple samples at the same time. The barcodes are used in the discrimination of different samples, and have no influence on other functions of the DNA molecule containing the added barcode. The barcode can have a length of 4 to 12 bp.

In this embodiment, the sequencing depth used in the acquisition of sequencing results of a test sample is preferably 0.2×, and a small fragment library is used with a size preferably of 100 to 300 bp. In other embodiments, the sequencing depth can be preferably 0.1× to 0.3×, simultaneously or optionally, the library has a size preferably of 50 to 500 bp. Using the above various preferred low sequencing depths and small fragment libraries, not only can the data size of sequencing be reduced to save the cost and shorten the time for detection and analysis, but the reliability and accuracy of the detection results can also be ensured. For example, in one embodiment, the employment of a sequencing depth of 0.2× and a library with a size of about 100 bp can allow the resulting sequencing data requiring analysis to be about 5M, greatly reducing the cost for generating the data, and reducing the difficulty in the analytical calculation as well, making it possible to complete the analysis process within 24 hr, and to facilitate the shortening of result feedback time.

(3) The reference sequence is divided into multiple windows, and the distribution of the sequencing results of the test sample on the reference sequence is reported as the number of sequence reads falling within each of the windows.

For the sake of simplicity, the number of the sequence reads in each window is denoted as r(i,j), wherein i is the serial number of the windows, j is the serial number of the test samples, and i and j are positive integers. As described above, for control samples, r(i,j) can be determined and saved in advance.

The reference sequence used is a known sequence, and can be any reference template in a biologic category to which the previously obtained target individual belongs. For example, if the target individual is a human being, a reference sequence of a human genome in the USA National Center for Biotechnology Information (NCBI) database may be selected as the reference sequence. In this embodiment, a human genome reference sequence of version 37.3 (hg19; NCBI Build 37.3) in the NCBI database is selected as the reference sequence.

The windows can be divided on the reference sequence using various modes that allow effective statistics of the sequencing results. For example, in this embodiment, the windows are divided according to a fixed window length and a fixed window spacing, wherein the fixed window length is preferably 100 Kb, and the fixed window spacing is preferably 10 kb or 20 kb. In other embodiments, a different fixed window length and fixed window spacing may also be selected. For example, the fixed window length is preferably 1 kb to 1 Mb, and simultaneously or optionally, the fixed window spacing is preferably 1 kb to 100 kb. The window length and spacing can be set according to the abundance of fetal DNA in the sample, based on the principle that each window corresponds to one statistical magnitude and one chromosomal position, which means that the distance between the windows determines the detection precision.

When the sequencing results are aligned with the reference sequence, various alignment software, e.g., Tmap, BWA (Burrows-Wheeler Aligner), SOAP (Short Oligonucleotide Analysis Package), samtools and the like, may be used, which are not limited in this embodiment. According to the alignment software, fault tolerant (i.e., several base mismatches are permitted) or non-fault tolerant alignments may be employed. When the fault tolerant alignment is employed, generally 1 to 3 faults are permitted in 100 bp on average. When a Proton platform is employed for sequencing, generally fault tolerance alignment is employed.

102. Calculating the Relative Sequence Number in Each Window of Each Test Sample

For the sake of simplicity, the relative sequence number in each window of each test sample is denoted as R(i,j),

R(i,j)=r(i,j)/rp(j)

wherein, rp(j) is an average value of r(i,j) of the sample j, e.g., it can be expressed as,

rp(j)=[r(1,j)+ . . . +r(I,j)]/I

wherein, I is the number of all windows on the reference sequence.

It should be stated that, in this embodiment, a subsequent analytic operation is performed using the relative sequence number after normalization, to highlight the statistical significance of the data themselves. In other embodiments, if the subsequent data analysis is performed without normalization, but with the use of the methods according to the present invention, and unnormalized numerical value levels are used only in the numerical analysis, calculation and comparison, such cases should be considered to be equivalent to this embodiment. In all the computational processes involved below, formulae or algorithms may also be varied employing mathematically or statistically equivalent or approximate methods, and should also be considered as equivalent, and unnecessary details are not given. This embodiment is not limited to the expression format of particular calculation formulas.

103. Calculating the Deviation Statistic in Each Window of Each Target Sample

For the sake of simplicity, the deviation statistic in each window of each target sample is denoted as Z(i,j),

Z(i,j)=[R(i,j)−mean(i)]/sd(i)

where, mean(i) is an average value of R(i,j) in the window i, e.g., it can be expressed as,

mean(i)=[R(i,1)+ . . . +R(i,J)]/J

sd(i) is standard deviation of R(i,j) in the window i, and one optional computing mode is:

$$sd ( i ) = \sqrt{\frac{1}{J - 1} {\sum }_{j = 1}^{J} {[ R ( i , j ) - mean ( i ) ]}^{2}}$$

Wherein, J is the number of all test samples. In this embodiment, J=1+N. In other embodiments, if the test sample also comprises M target samples, J=M+N.

The deviation statistic Z(i,j) represents whether a deletion or duplication is present in the window i of the sample j. Under the current form of the calculation formula, Z(i,j)>0 indicates a tendency for duplication, Z(i,j)<0 indicates a tendency for deletion, and Z(i,j) of each window has relative independent statistic significance.

104. Comparing an Average Value of the Deviation Statistics on a Certain Chromosome of the Target Sample with the Corresponding Deviation Threshold

(1) The deviation statistic Z(i,j) is subjected to analytic alignment according to the chromosome to which it belongs, i.e., the average value Zp(c,j) of Z(i,j) on chromosome c of the target sample is compared with the deviation threshold of chromosome c,

Zp(c,j)=[Z(c1,j)+ . . . +Z(cI−c1+1,j)]/cI

Wherein, c1 is the serial number of the first window on chromosome c of the reference sequence, and cI is the number of all windows on chromosome c of the reference sequence.

As described above, the use other statistic values having the same or approximate meaning, e.g., an accumulated value, instead of the use of an average value, is also an equivalent practice, as long as the numerical value of the threshold is adjusted.

(2) It is determined whether there is a deletion or duplication on chromosome c of the target sample using the comparison results. For example, if Zp(c,j) exceeds an upper limit of the deviation threshold, it can be concluded that chromosome c of the target sample j has a duplication (e.g., trisomy), and if Zp(c,j) is lower than a lower limit of the deviation threshold, it can be concluded that chromosome c of the target sample j has a deletion (e.g., monosome). Therefore, analytic results of a digitalized karyotype of the target sample can be given, for example, “chromosomal trisomy 21,” “chromosomal trisomy 18,” “chromosomal trisomy 13,” “deletion of X chromosome,” “deletion of Y chromosome,” and the like.

Importantly, although results of the variation detection according to embodiments of the present invention can objectively be used to determine a chromosomal aneuploidy, and thereby to detect genetic diseases caused thereby, e.g., fetal Downs syndrome, Edward syndrome and the like, the variation detection according to embodiments of the present invention are not necessarily used for diagnosis of diseases or associated purposes, for example, the presence of some chromosomal variation does not represent a disease risk or health condition, or the results can be used in basic science studies of genetic polymorphism.

(3) The deviation threshold is set according to the deviation statistics on chromosome c of all normal individuals. As described above, because the deviation threshold is obtained from the control sample, and thus can be calculated and saved in advance, when the target individual is subsequently subjected to detection, the same threshold setting can be used as long as the collection of the control sample is unchanged. Of course, if the control samples are reduced, replaced or increased, the corresponding deviation thresholds must be updated. One preferred threshold setting mode employed in this embodiment includes the steps as follows.

(3.1) Control samples of N normal individuals are used as the entire test samples, and Zp(c,j) of each control sample is calculated. A particular computational process can be performed as described in the above steps, except that the test samples no longer comprise any target samples, and thus when a deviation threshold is set, the number of all test samples is N. In order to make the obtained deviation threshold more reliable, in this embodiment, N is preferably not less than 30.

(3.2) The corresponding Zp(c,j) value boundary determined to be normal is calculated according to the set test rules and confidence degrees, and is used as a deviation threshold of chromosome c. Test rules can be selected and corresponding confidence degrees can be set according to the number of control samples and the desired detection precision and the like, details of which can be performed according to the existing mode for statistical data processing. In this embodiment, a U test is preferably employed, with a confidence degree of 95%, at which confidence degree, an advantage of “no false negative” exists. In other embodiments, other test rules such as a T test may also be selected, and simultaneously or optionally, the confidence degree may be selected as 90% to 99.9%, e.g., 99%, 99.5%, 99.9%, and the like.

In this embodiment, a group of deviation thresholds obtained according to the above setting mode are as listed below, wherein the recorded data has a format of (serial number of the chromosome; lower limit of the threshold; upper limit of the threshold):

(1; −0.1417365; 0.1417365) (2; −0.09237466; 0.09237466)

(3; −0.1250404; 0.1250404) (4; −0.1265542; 0.1265542)

(5; −0.08148388; 0.08148388) (6; −0.119122; 0.119122)

(7; −0.1061317; 0.1061317) (8; −0.1155915; 0.1155915)

(9; −0.1004392; 0.1004392) (10; −0.1106214; 0.1106214)

(11; −0.09819914; 0.09819914) (12; −0.09005814; 0.09005814)

(13; −0.1779642; 0.1779642) (14; −0.1436377; 0.1436377)

(15; −0.1478246; 0.1478246) (16; −0.1764641; 0.1764641)

(17; −0.147383; 0.147383) (18; −0.1891044; 0.1891044)

(19; −0.3332986; 0.3332986) (20; −0.206487; 0.206487)

(21; −0.2573099; 0.2573099) (22; −0.2096556; 0.2096556)

(X-male fetus; −0.823347; 0.823347) (X-female fetus; −0.285388; 0.285388)

(Y-male fetus; −1.228768; 1.228768) (Y-female fetus; −1.217151; 1.217151)

### Example 2

According to another embodiment of the present invention, a method for detecting chromosomal aneuploidy is provided, with the basic steps being the same as those in Example 1, except that Example 1 employs a mode of dividing windows according to a fixed window length and a fixed window a spacing, whereas this embodiment divides windows employing a mode in which each window comprises the same number of the unique alignment sequence.

The unique alignment sequence refers to a sequence located in a unique position of the reference sequence. Under a circumstance where windows are divided using a mode in which “each window comprises the same number of the unique alignment sequence”, when sequencing results of the test sample are aligned with the reference sequence, only sequence reads with unique alignments may be counted, and therefore sequence reads incapable of unique alignment are abandoned. This type of windows can reduce the influence of repetitive sequences, the N regions and the like on the detection results, to thereby improve reliability of the detection.

This embodiment provides a method for dividing windows according to a mode in which each window comprises the same number of unique alignment sequences, with reference to FIG. 2, which includes the steps as follows:

201. Acquire a Group of Known Base Sequences.

This group of base sequences can be acquired by performing whole genome sequencing on a certain know sample, e.g., one of the above control samples, or alternatively can be acquired by cutting the reference sequence according to a cut length.

When this group of known base sequences is acquired employing a mode of practical sequencing, in order to acquire a sufficient amount of the base sequences, the know sample selected may be subjected to deep sequencing, and the sequence reads obtained from the sequencing are used as this group of known base sequences. Preferably, the base sequence acquired may have a length comparable to that of sequence reads obtained by sequencing the test sample, by selecting methods of library construction and sequencing.

In the simulation of formation of this group of known base sequences employing a mode of cutting the reference sequence, the cut length may be determined first, generally according to the length of the sequence reads obtained by sequencing the test sample. For example, the cut length may also be a fixed length close to the length of the sequence reads of the test sample. For example, if the sequence reads of the test sample are about 250 bp, the cut length may be selected to be 200 to 300 bp. Then, the reference sequence is cut according to the cut length, e.g., HG18 or HG19 is cut according to a selected reference sequence.

202. Align this Group of Known Base Sequences with the Reference Sequence, to Obtain the Distribution of the Unique Alignment Sequence.

203. Divide into Windows.

For example, K unique alignment sequences are combined into a group, such that the sequences are divided into windows each containing K unique alignment sequences, wherein K is a positive integer.

### Example 3

According to another embodiment of the present invention, a method for detecting chromosomal aneuploidy is provided, with the basic steps being the same as those in Example 1 or 2, except that Examples 1 and 2 employ the relative sequence number that is not calibrated to calculate the deviation statistic Z(i,j), whereas in this embodiment, calibration on R(i,j) is performed first before the calculation of Z(i,j). For the sake of simplicity, the calibrated R(i,j) is expressed hereinafter as Ra(i,j).

In this embodiment, R(i,j) is preferably calibrated according to the GC (guanine and cytosine) content in each window of each test sample, to obtain Ra(i,j) having or approximately having normal distribution. Ra(i,j) is used when Z(i,j) is calculated. This is because viewed objectively, the influences of chromosomal aneuploidy (deletion or duplication) on the windows within the coverage range should be consistent, and the determined statistical magnitude R(i,j) should satisfy the common statistical distribution, e.g., normal or standard normal distribution. According to the existing research results, the GC content will influence the practical sequencing result. For example, the quantity of sequence reads in a region with a high or low GC content is lower than that with a moderate GC content, which is mainly associated with the library construction method used in the sequencing process. Therefore, in order to make the detection results more reliable, R(i,j) can be subjected to standardized calibration according to the GC content in each window of the test sample, to allow Ra(i,j) to have a statistic rule that is, for example, approximately in line with normal distribution. The distribution of R(i,j) or Ra(i,j) mentioned refers to the distribution of numerical values of R(i,j) described, with numerical values of R(i,j) as a horizontal coordinate, and the number of the windows containing the same numerical value of R(i,j) as a longitudinal coordinate. “The same numerical value” as used herein refers to values within the same gear range.

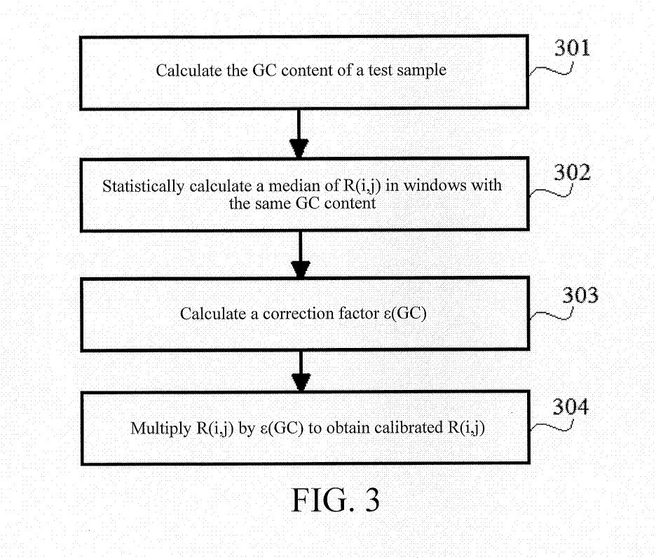

This embodiment provides a method for calibrating R(i,j) according to the GC content, with reference to FIG. 3, which includes the steps as follows:

301. Calculate the GC Content of the Test Sample.

For one test sample, the GC content in each window of the test sample can be calculated according to sequencing results. The target sample and the normal sample may be subjected to the calibration based on the GC content, as described above, or correlating data of the normal sample may be acquired and analyzed in advance.

302. Statistically Calculate a Median of R(i,j) in Windows with the Same GC Content.

“The same GC content” as used herein means that the GC content value lies in the same gear range. For example, in this embodiment, the gear range has a span preferably of 0.001. In other embodiments, the gear range has a span preferably from 0.0005 to 0.005.

303. Calculate a Correction Factor ε(GC).

Generally, the correction factor ε(GC) is a ratio of the median to a target value at a corresponding GC content. The target value is generally selected to be a value that can represent an average quantity level. For example, in this embodiment, the target value is preferably an average value of R(i,j) in all windows (including all chromosomes) of the sequencing sample.

304. Multiply R(i,j) by ε(GC) to obtain calibrated R(i,j), e.g., Ra(i,j) can be expressed as,

Ra(i,j)=ε(GC)×R(i,j)

It is readily apparent that it is also possible to subject R(i,j) directly to GC calibration, a method equivalent to the above calibration process.

Those of ordinary skill in the art can understand that all or parts of the steps of the various methods in the above embodiments can be achieved by programming related hardware with a program that may be stored in a computer readable storage medium, which may include: a read-only memory, a random access memory, a magnetic disk or an optical disk, and the like.

According to another aspect of the present invention, a device for detecting chromosomal aneuploidy is further provided, which includes: a data input unit, configured to input data; a data output unit, configured to output data; a storage unit, configured to store data, and containing an executable program therein; a processor, in data connection with the data input unit, the data output unit and the storage unit, and configured to execute the executable program stored in the storage unit, wherein the execution of the program includes performing all or parts of the steps of the various methods in the above embodiments.

Operation results according to the particular detection method of the present invention are described below in detail, in conjunction with particular target individuals. A particular parameter setting that is used in the following detection process is as follows:

1. The detection method of Example 3 is used, wherein the window setting mode of Example 1 is used,

2. The reference sequence is a human genome reference sequence of version 37.3 (hg19; NCBIBuild37.3) in the NCBI database,

3. The window length is 100 Kb, and the window spacing is 20 kb,

4. The target samples are 4 cases of maternal plasma, and the control samples are a group of control samples determining the deviation threshold listed in Example 1.

The detection process is as follows:

1. DNA extraction and library construction: DNAs of the 4 cases of plasma samples (serial numbers of the target individuals are included in the following table) are extracted using a Snova DNA extraction kit (SnoMag Circulating DNA Kit). The extracted DNA samples are subjected to library construction according to a proton library construction scheme after they are tested to be stable. Sequencing joints are added onto both ends of the DNA molecules with an average fragment size of 170 bp, and different barcodes are added to each target sample when the joints are connected, allowing for sample discrimination. A constructed library (with an average fragment size of about 250 bp) is subjected to emulsion PCR into a water in oil state, to form wrapped monomolecular particles.

2. Sequencing: the DNA samples obtained from the above 4 cases of plasma are sequenced using the Ion Proton protocol from Life Technologies, to carry out computer sequencing, and each sample is discriminated according to the barcodes. An alignment software Tmap (available from homepage of the Life Technologies Company) is utilized to subject sequencing results to non-fault tolerant alignment with the reference sequence, so as to overlay the target sequencing results on the reference sequence.

3. Data analysis: Zp(c,j) of each target sample (each target sample forms a group with the control samples) is calculated, and filtered using a corresponding deviation threshold, to obtain detection results exceeding the threshold.

4. Result inspection: the same 4 target individuals are analyzed according to a standard method of karyotype analysis (including processes such as amniocentesis, cell culturing, staining, and zoning), and analytic results are aligned with the results in step 3, as shown in the table as follows:

| | | | Detection | |
|---|---|---|---|---|
| | | | results | |
| | | | according | |
| Serial | | Results of | to the | |
| number | Serial | standard | method of | |
| of target | numbers of | karyotype | the present | |
| individuals | chromosomes | analysis | invention | Conclusion |
| CQPT01 | 21 | 47, XY, +21 | 47, XY, +21 | Consistent |
| CQPT02 | 18 | 47, XX, +18 | 47, XX, +18 | Consistent |
| CQPT03 | 13 | 47, XY, +13 | 47, XY, +13 | Consistent |
| CQPT04 | X | 45, XO | 45, XO | Consistent |

The above are only preferred examples of the present invention, and it should be understood that these examples are only used to explain the present invention, and do not limit the present invention. Those ordinarily skilled in the art can vary the above particular embodiments according to the idea of the present invention.

What is claimed is:

1. A method for detecting chromosomal aneuploidy, comprising the following steps:
obtaining a distribution of sequencing results of test samples on a reference sequence, wherein the test samples comprise target samples derived from M target individuals and control samples derived from N normal individuals, M and N are positive integers, the sequencing results include a plurality of sequence reads, a plurality of windows are divided on the reference sequence, and the distribution is reported as the number of sequence reads r(i,j) falling within each of the windows, wherein i is the serial number of the window, j is the serial number of the test sample, and i and j are positive integers;
calculating the relative sequence number R(i,j)=r(i,j)/rp(j) of each test sample in each of the windows, wherein rp(j) is an average value of r(i,j) of sample j;
calculating the deviation statistic Z(i,j)=[R(i,j)−mean(i)]/sd(i) of each target sample in each window, wherein mean(i) is an average value of R(i,j) in window i, and sd(i) is a standard deviation of R(i,j) in window i; and
comparing the average value Zp(c,j) of Z(i,j) on chromosome c of the target samples with a deviation threshold of the chromosome c, and
determining whether there is a deletion or duplication in the chromosome c according to the comparison results, wherein the deviation threshold is set according to the deviation statistics of all of the N normal individuals on the chromosome c.

2. The method according to claim 1, wherein the target samples and the control samples are from a source of at least one selected from the group consisting of: maternal peripheral blood, maternal urine, fetal trophoblast cells of maternal cervix, maternal cervical mucus, and fetal nucleated red blood cells.

3. The method according to claim 1, wherein the plurality of windows are divided in a mode selected from the group consisting of: dividing the windows according to a fixed window length and a fixed window spacing, and dividing the windows according to a method in which each window comprises the same number of unique alignment sequences, and
the fixed window length is 1 kb to 1 Mb.

4. The method according to claim 3, wherein the plurality of windows are divided in a mode in which each window comprises the same number of the unique alignment sequences via a method comprising:
acquiring a group of known base sequences by sequencing known samples, or by cutting the reference sequence according to a cut length determined by the length of sequence reads acquired by sequencing the test sample,
aligning the known sequence reads with the reference sequence to acquire the distribution of the unique alignment sequences, and
combining K adjacent unique alignment sequences into a group, thereby dividing the reference sequence into windows covering the unique alignment sequences in each group, wherein K is a positive integer.

5. The method according to claim 1, wherein prior to calculating Z(i,j), the method further comprises: calibrating R(i,j) according to the GC content in each window of each test sample such that the calibrated R(i,j) has approximately normal distribution, and using the calibrated R(i,j) for the calculation of Z(i,j).

6. The method according to claim 5, wherein the calibration of R(i,j) includes steps of:
for one test sample, calculating the GC content in each window of the test sample according to the sequencing results,
performing statistical analysis of the median of R(i,j) in the window with the same GC content, wherein the same GC content means that the GC content value lies in the same gear range with a span from 0.0005 to 0.005,
using a ratio of the median to a target value as a correction factor ε(GC) under a corresponding GC content, wherein the target value is an average value of R(i,j) of all the windows of the test sample, and
multiplying R(i,j) by ε(GC) to acquire the calibrated R(i,j).

7. The method according to claim 1, wherein the sequencing depth used in the acquisition of sequencing results of the test sample is 0.1× to 0.3×; and/or
a sequencing library constructed in the sequencing of the test sample has a size of 50 to 500 bp.

8. The method according to claim 1, wherein the deviation threshold is set by steps comprising:
calculating Zp(c,j) of each control sample, with the control samples derived from the N normal individuals as the total test samples, and
determining boundary values of Zp(c,j) corresponding to the normal individuals according to set test rule and confidence degree, and using the boundary values as the deviation threshold of chromosome c;
wherein the set test rule is U test; and/or
the confidence degree is from 90% to 99.9% and/or,
the N is not less than 30.

9. The method according to claim 1, wherein the sd(i) is calculated according to the following mode:
$$sd ( i ) = \sqrt{\frac{1}{J - 1} {\sum }_{j = 1}^{J} {[ R ( i , j ) - mean ( i ) ]}^{2}} ,$$
wherein J is the number of all the test samples.

10. A device for detecting chromosomal aneuploidy, comprising:
a data input unit, configured to input data;
a data output unit, configured to output data;
a storage unit, configured to store data, and containing an executable program therein; and
a processor, in data connection with the data input unit, the data output unit and the storage unit, and configured to execute the executable program, wherein the execution of the program includes performing the method according to claim 1.

11. A computer readable storage medium, configured to store a program executable by a computer, and the execution of the program comprises performing the method according to claim 1.
